(19) United States
(12) Patent Application Publication
(10) Pub. No.: US 2026/0215442 A1
(43) Pub. Date: Jul. 30, 2026

(54) SAUSAGE FILLING MACHINE

(71) Applicants: INTRADIN (SHANGHAI) INTELLIGENT MACHINERY CO., LTD., Shanghai (CN); INTRADIN (SHANGHAI) MACHINERY CO., LTD., Shanghai (CN)

(72) Inventors: Xiaobo XU, Shanghai (CN); Junliang WANG, Shanghai (CN)

(21) Appl. No.: 19/577,317

(22) Filed: Mar. 24, 2026

(30) Foreign Application Priority Data
Apr. 29, 2025 (CN) 202520834321.5

(51) Int. Cl. A22C 11/04

(52) U.S. Cl. CPC A22C 11/04

(57) ABSTRACT

A sausage filling machine, including a base, a frame, a stuffing barrel, a pushing assembly, a driving structure and a limiting part. The frame is mounted on the base. A bottom of the stuffing barrel is rotatably connected to the frame. The pushing assembly is configured to press stuffing within the stuffing barrel. The driving structure and the pushing assembly are provided on a top of the frame. The driving structure is configured to drive the pushing assembly to move up and down within the stuffing barrel. The limiting part is configured to limit a tilting angle of the stuffing barrel and maintain the stuffing barrel in a tilted state.

### CROSS-REFERENCE TO RELATED APPLICATIONS

This application claims the benefit of priority from Chinese Patent Application No. 202520834321.5, filed on April 29, 2025. The content of the aforementioned application, including any intervening amendments made thereto, is incorporated herein by reference in its entirety.

### TECHNICAL FIELD

This application relates to sausage production, and more particularly to a sausage filling machine.

### BACKGROUND

Sausage is one of the most commonly-consumed food products. Sausage filler is a crucial component in the preparation of sausages, which can continuously, automatically and quantitatively fill the casing with the relatively dry stuffing. In the sausage filling machine, a stuffing barrel is the main component responsible for storing and shaping the stuffing.

For the existing vertical sausage filling machines, it is often required to rotate the stuffing barrel to a tilted posture to facilitate the loading. However, it is required to manually hold the tilted barrel in place during the loading process, which will result in inconvenient operation and high labor intensity. In view of this, a sausage filling machine is provided herein to address such problems.

### SUMMARY

An object of the disclosure is to provide a sausage filling machine to overcome the defects in the prior art.

Technical solutions of the present disclosure are described as follows.

A sausage filling machine, comprising: a base; a frame; a stuffing barrel; a pushing assembly; and a driving structure; the frame is mounted on the base;a top of the stuffing barrel is configured to engage with the frame; and a bottom of the stuffing barrel is rotatably connected to the frame; the pushing assembly is configured to press stuffing within the stuffing barrel; and the driving structure and the pushing assembly are provided on a top of the frame; and the driving structure is configured to drive the pushing assembly to move up and down within the stuffing barrel.

In some embodiments, a bottom of each of two sides of the stuffing barrel is provided with a rotating seat; two sides of the frame are each provided with a rotating shaft corresponding to the rotating seat; and the rotating shaft is rotatably connected to the rotating seat.

In some embodiments, the sausage filling machine further comprises a limiting part; and the limiting part is configured to limit a tilting angle of the stuffing barrel and maintain the stuffing barrel in a tilted state.

In some embodiments, the limiting part comprises a hook and an engagement structure; the engagement structure is provided on a side wall of the stuffing barrel, and is provided with an engagement portion; and a first end of the hook is pivotally connected to the frame, and a second end of the hook is configured to engage with the engagement portion.

In some embodiments, a side of the hook adjacent to the frame is provided with a stop bar.

In some embodiments, the limiting part is a locking chain; two ends of the locking chain are respectively mounted on inner sides of the frame at a position adjacent to an opening of the stuffing barrel.

In some embodiments, the limiting part is a supporting block; the supporting block is mounted on the base, and is located at a side of an axis of the rotating shaft; and in response to a case that the stuffing barrel is tilted, the supporting block is configured to support the bottom or a side wall of the stuffing barrel.

In some embodiments, the sausage filling machine further comprises a positioning assembly; and the positioning assembly is configured to position the stuffing barrel and maintain the stuffing barrel in a vertical state.

In some embodiments, the positioning assembly comprises a positioning pin and the engagement structure; and the positioning pin is provided on the frame; and in response to a case that the stuffing barrel is in the vertical state, the positioning pin is configured to engage with the engagement portion of the engagement structure.

In some embodiments, a bottom of a side wall of the stuffing barrel is provided with a discharge port; a stuffing tube is sleevedly connected with the discharge port; a first end of the stuffing tube is connected with the discharge port; an inner diameter of the first end of the stuffing tube is configured to fit an outer diameter of the discharge port; and an inner diameter of a second end of the stuffing tube is configured to be adjustable.

Compared to the prior art, the present disclosure has the following beneficial effects.

In the present disclosure, by providing the limiting part, the stuffing barrel can remain in an inclined state during feeding without requiring manual support, thereby making the feeding operation more convenient compared with the prior art.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated in these drawings without making creative effort.

FIG. 1 schematically shows an overall structure of a sausage filling machine according to an embodiment of the present disclosure;

FIG. 2 is a sectional view of the sausage filling machine according to an embodiment of the present disclosure;

FIG. 3 is a front view of the sausage filling machine according to an embodiment of the present disclosure;

FIG. 4 is a structural diagram of a positioning pin of the sausage filling machine according to an embodiment of the present disclosure;

FIG. 5 is an enlarged view of portion “A” in FIG. 1;

FIG. 6 is a structural diagram of a locking chain of the sausage filling machine according to an embodiment of the present disclosure; and

FIG. 7 is a structural diagram of a supporting block of the sausage filling machine according to an embodiment of the present disclosure.

In the figures: 1-base; 2-frame; 21-positioning pin; 3-stuffing barrel; 31-discharge port; 32-handle; 33-stuffing tube; 34-engagement structure; 35-rotating seat; 341-engagement portion; 4-rotating shaft; 5-pushing assembly; 51-piston; 52-push rod; 6-driving structure; 7-hook; 71-stop bar; 8-locking chain; and 9-supporting block.

The implementation, functional characteristics, and advantages of the present disclosure will be further described in conjunction with the embodiments and the accompanying drawings.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure.

It should be noted that all directional indications (such as up, down, left, right, front, and back) in the embodiments of the present disclosure are used only for explaining the relative positional relationship or movement between the components in a particular attitude (as shown in the accompanying drawings), and the directional indications are correspondingly changed if the particular attitude is changed.

Furthermore, terms such as “first” and “second” are only descriptive, and should not be construed as indicating or implying their relative importance or implicitly specifying the number of technical features indicated. As a result, a feature defined as “first” or “second” may include at least one of such features, either explicitly or implicitly. In addition, “and/or” includes three solutions, for example, “A and/or B” includes technical solution A, technical solution B, and a combination thereof. In addition, the technical solutions of various embodiments may be combined with each other on the premise that the combined solution can be implemented by those of ordinary skill in the art. When the combination of technical solutions appears to be contradictory or unimplementable, it should be understood that such a combination does not exist, and is not included within the scope of the present disclosure.

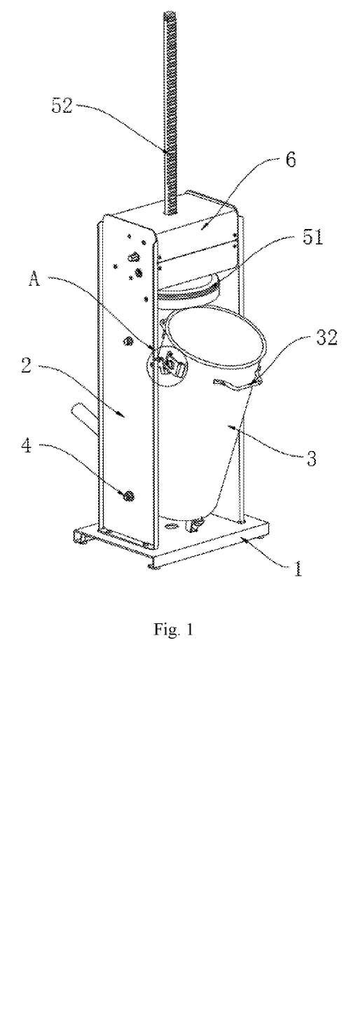

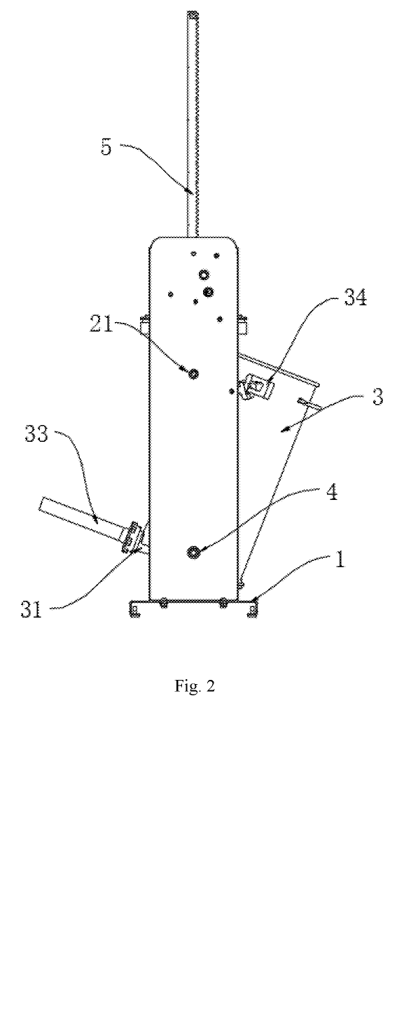

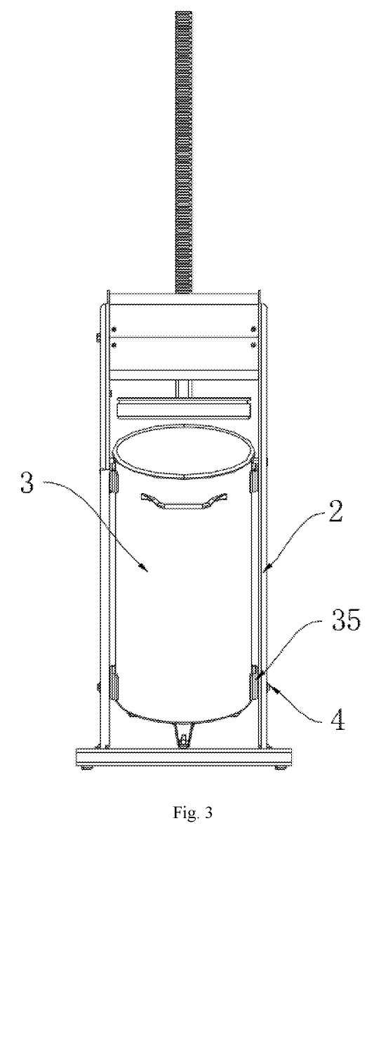

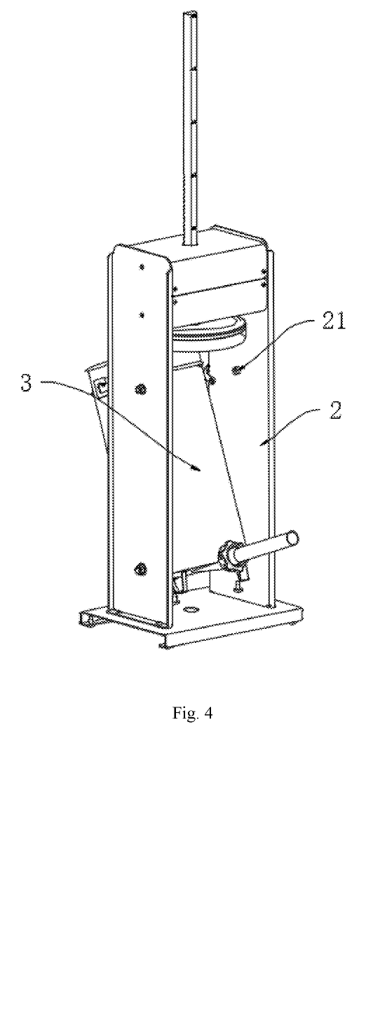

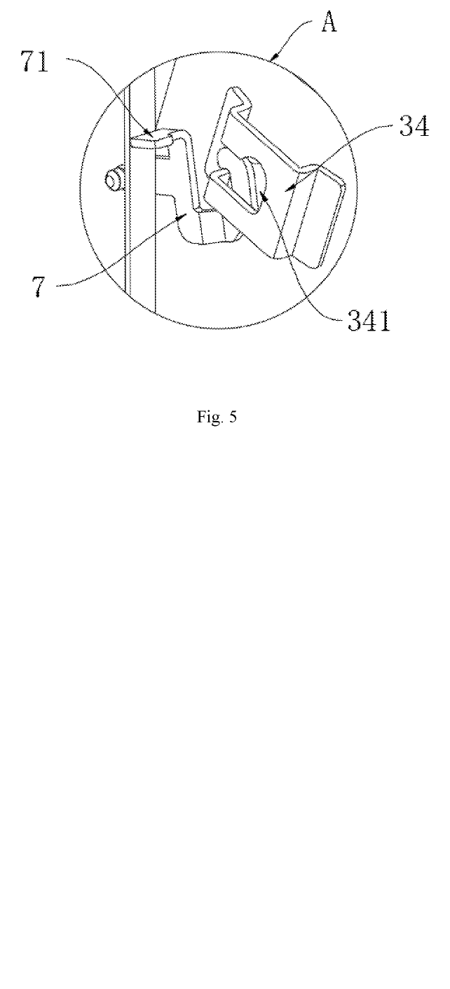

As shown in FIGS. 1-5, an embodiment of the present disclosure provides a sausage filling machine, including a base 1, a frame 2, a stuffing barrel 3, a pushing assembly 5, a driving structure 6 and a limiting part 7. The frame 2 is detachably mounted on the base 1. The frame 2 are provided on two sides of the stuffing barrel 3. A bottom of each of the two sides of the stuffing barrel 3 is provided with a rotating seat 35. Two sides of the frame are each provided with a rotating shaft corresponding to the rotating seat 35. The rotating shaft 4 is rotatably connected to the rotating seat 35. The stuffing barrel 3 is rotatably connected to the frame 2 through the rotating shaft 4. A top of the stuffing barrel 3 is configured to engage with the frame 2. A gap is formed between a bottom of the stuffing barrel 3 and the base 1. The pushing assembly 5 is configured to press stuffing within the stuffing barrel 3. The driving structure 6 and the pushing assembly 5 are mounted on the frame 2, and are located above the stuffing barrel 3. The driving structure 6 is configured to drive the pushing assembly 5 to move up and down within the stuffing barrel 3. The limiting part 7 is configured to limit a tilt angle of the stuffing barrel 3 and maintain the stuffing barrel 3 in a tilted state.

In this embodiment, the frame 2 is plate-shaped. The number of the frame 2 is two, and two frames 2 are arranged in parallel and spaced apart on the base 1. The stuffing barrel 3 is located between the two frames 2. The driving structure 6 includes a motor and a gear (not shown in the figures).

During operation, the stuffing barrel 3 is rotated about the rotating shaft 4 into a tilted state. During feeding, the limiting part 7 maintains the stuffing barrel 3 in the tilted state without requiring manual support, allowing stuffing to be added into the stuffing barrel 3. After feeding is completed, the stuffing barrel 3 is returned to an upright position. Subsequently, the driving structure 6 drives the pushing assembly 5 to press the stuffing within the stuffing barrel 3, thereby performing the sausage filling operation.

In the present disclosure, by providing the limiting part 7, the stuffing barrel 3 can remain in the tilted state during feeding without requiring manual support, thereby making the feeding operation more convenient compared with the prior art.

In an embodiment, the pushing assembly 5 includes a piston 51 and a push rod 52. The piston 51 is slidably connected to the stuffing barrel 3. A first end of the push rod 52 is connected to the piston 51, and a second end of the push rod 52 is connected to the driving structure 6. A side of the push rod 52 is serrated along a length direction of the push rod 52.

In this embodiment, the push rod 52 is configured to engage with the gear. The piston 51 is configured to abut against an inner wall of the stuffing barrel 3. The piston 51 is slidably connected to the inner wall of the stuffing barrel 3.

During operation, the motor drives the gear to rotate, which in turn drives the push rod 52 to move in a vertical direction. By adjusting a rotation direction of the motor, the push rod 52 can be repeatedly moved in a vertical direction. When the push rod 52 moves downward, it drives the piston 51 to press downward, thereby extruding the stuffing in the stuffing barrel 3 to perform sausage filling. When additional stuffing needs to be added, the push rod 52 is moved upward, causing the piston 51 to withdraw from the stuffing barrel 3.

In an embodiment, a bottom of a side wall of the stuffing barrel 3 is provided with a discharge port 31. A stuffing tube 33 is sleevedly connected with the discharge port 31.

In this embodiment, after the stuffing in the stuffing barrel 3 is pressed by the piston 51, the stuffing is extruded through the discharge port 31 and then fed into a casing through the stuffing tube 33.

In an embodiment, a first end of the stuffing tube 33 is connected with the discharge port. An inner diameter of a first end of the stuffing tube 33 is configured to fit an outer diameter of the discharge port 31. An inner diameter of a second end of the stuffing tube 33 is configured to be adjustable.

In this embodiment, the second end of the stuffing tube 33 is adjustable in terms of the inner diameter to be compatible with casings of various sizes to complete the sausage filling operations.

In an embodiment, an outer wall of the stuffing barrel 3 is provided with a handle 32.

In this embodiment, by providing the handle 32, the tilting and feeding of the stuffing barrel 3 are facilitated.

In an embodiment, the limiting part 7 includes a hook 7 and an engagement structure 34. The engagement structure 34 is provided on the side wall of the stuffing barrel 3, and is provided with an engagement portion 341. A first end of the hook 7 is connected to the engagement structure 34, and a second end of the hook 7 is connected to the frame 2.

In this embodiment, the engagement structure 34 is located on an outer wall of the stuffing barrel 3 adjacent to an opening of the stuffing barrel 3. When the stuffing barrel 3 is tilted, the hook 7 is configured to engage with the engagement structure 34, such that the hook 7 retains the engagement structure 34, thereby maintaining the stuffing barrel 3 at the current tilting angle and state.

In an embodiment, a side of the hook 7 adjacent to the frame 2 is provided with a stop bar 71.

In this embodiment, the stop bar 71 is provided, when the stuffing barrel 3 is returned to the upright position, the stop bar 71 is blocked by the frame 2, causing the hook 7 to automatically disengage from the engagement structure 34. Additionally, when the stuffing barrel 3 needs to be tilted, the stop bar 71 also facilitates lifting the hook 7 to engage with the engagement structure 34.

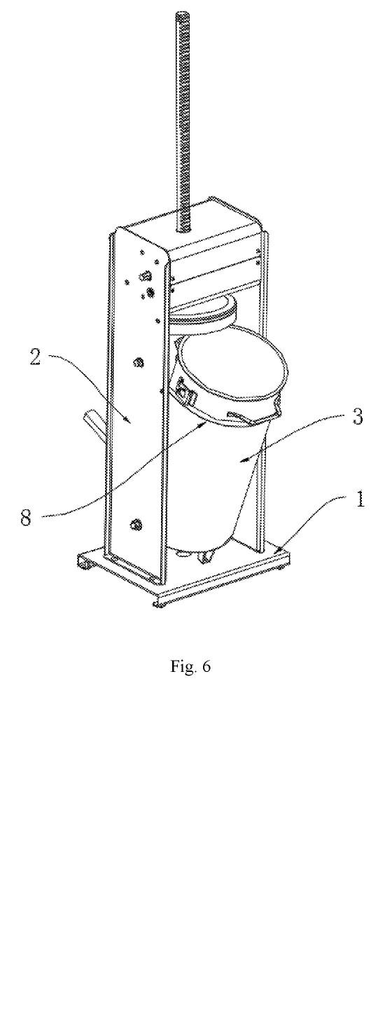

As shown in FIG. 6, in an embodiment, the limiting part 7 is a locking chain 8. Two ends of the locking chain 8 are respectively mounted on inner sides of the frame 2 at a position adjacent to the opening of the stuffing barrel 3.

In this embodiment, the locking chain 8 may be a rope or a chain. When the stuffing barrel 3 is tilted, the locking chain 8 supports the side wall of the stuffing barrel 3 adjacent to the opening of the stuffing barrel 3, thereby maintaining the tilted state of the stuffing barrel 3. By adjusting a length of the locking chain 8, the tilting angle of the stuffing barrel 3 can be adjusted.

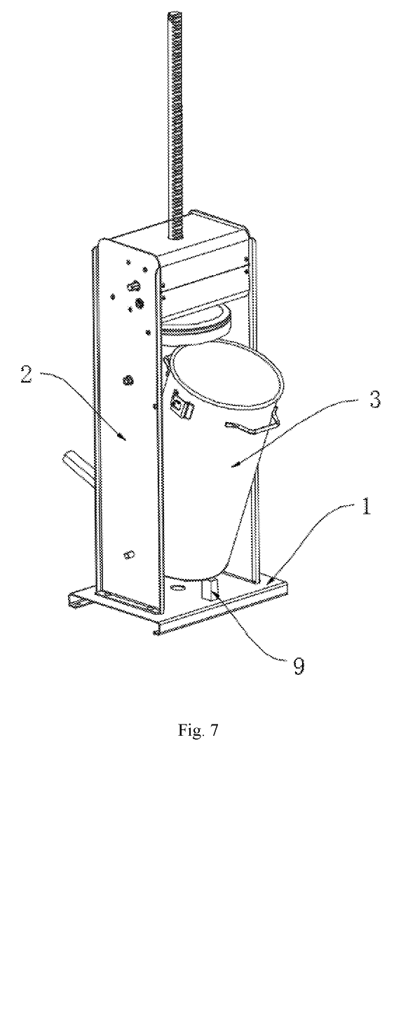

As shown in FIG. 7, in an embodiment, the limiting part 7 is a supporting block 9. The supporting block 9 is mounted on the base 1, and is provided on a side of an axis of the rotating shaft 4. When the stuffing barrel 3 is tilted, the supporting block 9 is configured to support the bottom or the side wall of the stuffing barrel 3.

In this embodiment, when the supporting block 9 supports the bottom of the stuffing barrel 3, a height of the supporting block 9 is less than a distance of the gap between the bottom of the stuffing barrel 3 and the base 1. When the supporting block 9 supports the side wall of the stuffing barrel 3, the height of the supporting block 9 is greater than the distance of the gap between the bottom of the stuffing barrel 3 and the base 1.

In an embodiment, the sausage filling machine further includes a positioning assembly. The positioning assembly is configured to position the stuffing barrel 3 and maintain the stuffing barrel 3 in a vertical state.

Specifically, the positioning assembly includes a positioning pin 21 and the engagement structure 34. The positioning pin 21 is provided on the frame 2. When the stuffing barrel 3 is in the vertical state, the positioning pin 21 is configured to engage with the engagement portion 341 of the engagement structure 34.

In this embodiment, the positioning pin 21 is configured to limit and position the stuffing barrel 3. When the stuffing barrel 3 is returned to the upright position, the positioning pin 21 is received in and engaged with the engagement portion 341 of the engagement structure 34, thereby maintaining the vertical state of the stuffing barrel 3.

Described above are merely preferred embodiments of the present disclosure, and are not intended to limit the scope of the present disclosure. Any equivalent structural changes made based on the description and the accompanying drawings of the present disclosure under the inventive concept of the present disclosure, or direct/indirect application in other related technical fields shall fall within the scope of the present disclosure defined by the appended claims.

What is claimed is:

1. A sausage filling machine, comprising:
a base;
a frame;
a stuffing barrel;
a pushing assembly;
a driving structure; and
a limiting part;
wherein the frame is mounted on the base;
a bottom of the stuffing barrel is rotatably connected to the frame;
the pushing assembly is configured to press stuffing within the stuffing barrel;
the driving structure and the pushing assembly are provided on a top of the frame; and the driving structure is configured to drive the pushing assembly to move up and down within the stuffing barrel; and
the limiting part is configured to limit a tilting angle of the stuffing barrel and maintain the stuffing barrel in a tilted state.

2. The sausage filling machine of claim 1, wherein a bottom of each of two sides of the stuffing barrel is provided with a rotating seat; two sides of the frame are each provided with a rotating shaft corresponding to the rotating seat; and the rotating shaft is rotatably connected to the rotating seat.

3. The sausage filling machine of claim 1, wherein the limiting part comprises a hook and an engagement structure; the engagement structure is provided on a side wall of the stuffing barrel, and is provided with an engagement portion; and a first end of the hook is pivotally connected to the frame, and a second end of the hook is configured to engage with the engagement portion.

4. The sausage filling machine of claim 3, wherein a side of the hook adjacent to the frame is provided with a stop bar.

5. The sausage filling machine of claim 1, wherein the limiting part is a locking chain; two ends of the locking chain are respectively mounted on two sides of the frame at a position adjacent to an opening of the stuffing barrel.

6. The sausage filling machine of claim 2, wherein the limiting part is a supporting block; the supporting block is mounted on the base, and is located at a side of an axis of the rotating shaft; and
in response to a case that the stuffing barrel is tilted, the supporting block is configured to support the bottom or a side wall of the stuffing barrel.

7. The sausage filling machine of claim 3, further comprising:
a positioning assembly;
wherein the positioning assembly is configured to position the stuffing barrel, and maintain the stuffing barrel in a vertical state.

8. The sausage filling machine of claim 7, wherein the positioning assembly comprises a positioning pin and the engagement structure; and the positioning pin is provided on the frame; and
in response to a case that the stuffing barrel is in the vertical state, the positioning pin is configured to engage with the engagement portion of the engagement structure.

9. The sausage filling machine of claim 1, wherein a bottom of a side wall of the stuffing barrel is provided with a discharge port; and a stuffing tube is sleevedly connected with the discharge port.

10. The sausage filling machine of claim 9, wherein a first end of the stuffing tube is connected with the discharge port; an inner diameter of the first end of the stuffing tube is configured to fit an outer diameter of the discharge port; and an inner diameter of a second end of the stuffing tube is configured to be adjustable.
